(19) United States
(12) Patent Application Publication
(10) Pub. No.: US 2026/0178924 A1
(43) Pub. Date: Jun. 25, 2026

(54) GENERATING DOCUMENT-GROUNDED TRAINING DATA FOR GENERATIVE MODELS

(71) Applicant: Adobe Inc., San Jose, CA (US)

(72) Inventors: Christopher Tensmeyer, Columbia, MD (US); Zichao Wang, San Jose, CA (US); Manya Wadhwa, Austin, TX (US)

(21) Appl. No.: 18/987,286

(22) Filed: Dec. 19, 2024

(51) Int. Cl. G06N 3/091

(52) U.S. Cl. CPC G06N 3/091

(57) ABSTRACT

The present disclosure relates to systems, non-transitory computer-readable media, and methods for generating a training dataset for AI agents by using large language models to simulate a conversation between a user and an AI agent. In some embodiments, the disclosed systems determine a synthetic persona by selecting a plurality of characteristics defining the synthetic persona. In some embodiments, the disclosed systems generate a synthetic prompt emulating text input by the synthetic persona utilizing a large language model to process a digital document associated with the synthetic persona. In some embodiments, the disclosed systems generate a synthetic response emulating text generated by an artificial intelligence agent responsive to the text input by the synthetic persona utilizing a second large language model to process the synthetic prompt. In some embodiments, the disclosed systems modify parameters of a neural network using the synthetic prompt and the synthetic response as training data.

### BACKGROUND

A key challenge in training generative models is the lack of available training data. For multi-turn conversational artificial intelligence (“AI”) models, gathering actual user data for training is often considered a violation of privacy and is therefore off limits. Moreover, curating and collecting real human-AI conversations at scale is computationally cost-prohibitive and often provides poor training data because of the unnatural, forced nature of the conversation. Thus, despite the advancements in AI agents, existing systems exhibit a number of drawbacks or disadvantages in generating robust training data for accurately training generative models in the multi-turn conversational domain.

### SUMMARY

This disclosure describes one or more embodiments of systems, methods, and non-transitory computer readable media that solve one or more of the foregoing or other problems in the art by generating a synthetic training dataset through modeling a conversation using large language models (“LLMs”) to predict user satisfaction and conversational goals. In some embodiments, the disclosed systems generate synthetic data emulating a multi-turn information-seeking conversation between a user and an AI agent. For example, the disclosed systems utilize a persona emulation LLM and an agent emulation LLM, along with other models (e.g., LLMs) to generate a synthetic conversation based on synthetic user personas, responses, satisfaction labels, and conversational goals. Using this framework of LLMs, in some embodiments, the disclosed systems use satisfaction labels to inform the generation of subsequent synthetic prompts and responses as part of an overall a synthetic conversation to include in a training dataset.

### BRIEF DESCRIPTION OF THE DRAWINGS

The disclosure describes one or more embodiments of the invention with additional specificity and detail by referencing the accompanying figures. The following paragraphs briefly describe those figures, in which:

FIG. 1 illustrates a diagram of an environment in which a generative training data system operates in accordance with one or more embodiments.

FIG. 2 illustrates a diagram of an overview of the generative training data system generating a training dataset by simulating a conversation between a persona emulation model and an agent emulation model evaluated by a satisfaction prediction model in accordance with one or more embodiments.

FIG. 3 illustrates a diagram of the persona emulation model generating a synthetic prompt in accordance with one or more embodiments.

FIG. 4 illustrates a diagram of generating a conversational goal in accordance with one or more embodiments.

FIG. 5 illustrates a diagram of generating an information data object in accordance with one or more embodiments.

FIG. 6 illustrates a diagram of the agent emulation model generating a synthetic response in accordance with one or more embodiments.

FIG. 7 illustrates a diagram of the satisfaction prediction model generating a predicted satisfaction label in accordance with one or more embodiments.

FIG. 8 illustrates a diagram of generating subsequent synthetic prompts and synthetic responses in accordance with one or more embodiments.

FIG. 9 illustrates experimental result data for the generative training data system in accordance with one or more embodiments.

FIG. 10 illustrates an example schematic diagram of a generative training data system in accordance with one or more embodiments.

FIG. 11 illustrates an example flowchart of a series of acts for generating a training dataset from iterative synthetic prompts and synthetic responses in accordance with one or more embodiments.

FIG. 12 illustrates a block diagram of an example computing device in accordance with one or more embodiments.

### DETAILED DESCRIPTION

This disclosure describes one or more embodiments of a generative training data system that generates a training dataset for training generative models, particularly in the context of multi-turn information-seeking conversational interactions. For example, the generative training data system uses a framework of multiple LLMs, including a persona emulation LLM, an agent emulation LLM, and a satisfaction prediction LLM (among other LLMs) to simulate a user-agent conversation. In some embodiments, the generative training data system generates a synthetic persona using a persona emulation LLM to process a digital document (e.g., a document about which a user asks multi-turn questions and/or provides multi-turn prompts). In some cases, the generative training data system determines a conversational goal and an information data object (corresponding to the conversational goal) to generate a synthetic prompt emulating a user interaction with an AI agent about the digital document.

In response to the synthetic prompt, in some embodiments, the generative training data system prompts the agent emulation LLM to generate a synthetic response emulating an AI agent response. In some cases, the generative training data system thus alternates between generating synthetic prompts and responses using respective LLMs. To further improve the realism and effectiveness of the training data, in one or more embodiments, the generative training data system prompts the satisfaction prediction LLM with the conversation history (including prior synthetic prompts and corresponding synthetic responses), the information data object, the conversational goal, and the digital document to generate a predicted satisfaction label. In some embodiments, the generative training data system utilizes the predicted satisfaction label to generate a subsequent synthetic prompt. In one or more embodiments, the generative training data system iteratively generates synthetic prompts, synthetic responses, and synthetic satisfaction labels to emulate a conversation with an AI agent for use as training data.

In one or more embodiments, the generative training data system determines a synthetic persona for a persona emulation LLM to utilize. Based on the synthetic persona, the generative training data system uses the persona emulation LLM to process a digital document to generate a synthetic prompt that emulates a text input by the synthetic persona. In some embodiments, the generative training data system uses an agent emulation LLM to process the synthetic prompt to generate a synthetic response that emulates the response of an AI agent. In one or more embodiments, the generative training data system uses the synthetic prompt and the synthetic response as training data to modify parameters of a separate neural network.

In some embodiments, the generative training data system uses a satisfaction prediction LLM to process the synthetic prompt and the synthetic response to determine a predicted satisfaction label from among a set of candidate satisfaction labels. In one or more embodiments, the generative training data system then utilizes the persona emulation LLM to generate a subsequent synthetic prompt based on the predicted satisfaction label. In some embodiments, the generative training data system uses the agent emulation LLM to process the subsequent synthetic prompt to generate a subsequent synthetic response. In some embodiments, the generative training data system iteratively generates subsequent synthetic prompts and subsequent synthetic responses to generate a training dataset.

In some embodiments, the generative training data system trains a generative model (e.g., a generative language model, such as a conversational LLM or AI agent) using the training dataset. Indeed, in one or more embodiments, the generative training data system uses the training dataset to improve the ability of the generative model to infer user conversational goals and information needs for ultimately providing improved responses to questions about a digital document. In some embodiments, by training the generative model with the generated training dataset, the generative training data system improves the ability of the generative model to generate responses that predict user satisfaction and respond accordingly.

Although conventional systems generate training data for AI agents to an extent, such systems have a number of problems or inadequacies in relation to accuracy, flexibility, and efficiency. For instance, conventional systems inaccurately generate training data that is overly simplistic and unrealistic. To illustrate, some conventional systems, when generating synthetic data, steer the conversation by randomly selecting a series of passages from the source document or by using a single LLM prompt, resulting in simplistic or unrealistic training data. Further, some conventional systems generate training data that does not account for conversational goals or other document-grounded data, thus limiting contextual understanding and resulting accuracy in responding to user prompts.

Additionally, conventional systems are inflexible. For instance, certain conventional systems are limited to training data labeled according to rigid rubrics, which generally consist of a limited set (e.g., 10) of conversational aspects and which are highly dependent on the domain of the conversation. Because rubrics are dependent on the domain of the conversation, they limit LLMs trained on resulting data to generating suitable responses only when queried about specific conversation domains. Due to their reliance on rubrics, conventional systems are often less proficient in inferring user intent in document-grounded dialogue.

Beyond being inaccurate and inflexible, some conventional systems are also inefficient. For instance, some conventional systems require human-labeled conversations as training data. Generating human-labeled conversations requires a large amount of time and a large number of participant devices to generate an actionable quantity of data. The expense and timing of this conventional approach is only made worse given that such systems generate a new set of human-labeled conversation data for each separate instance (or domain) of training.

As suggested, embodiments of the generative training data system provide several advantages and benefits over conventional systems. For example, by using the described framework of LLMs to synthesize human-agent conversation in a document-grounded sense (and by incorporating conversational goals and satisfaction labels), the generative training data system improves accuracy relative to conventional systems. Specifically, by prompting a persona emulation model with a specialized prompt that includes data regarding a synthetic persona, a conversational goal, and an information data object, the generative training data system realistically mimics user goals and interactions. Further, by masking the conversational goal and the information data object from the agent emulation model, the generative training data system generates training data that models inference of user conversational goals, improving accuracy in inferring user conversational goals. Consequently, the generative training data system generates more accurate training data for training robust generative models in multi-turn interactions, particularly interactions pertaining to a digital document.

The generative training data system also improves flexibility relative to conventional systems. Specifically, by generating synthetic prompts and synthetic responses emulating user prompts and responses about a digital document, the generative training data system generates training data about a variety of different subjects correlating with a variety of different digital documents. Further, by generating synthetic prompts and synthetic responses emulating user prompts and responses about a digital document, the generative training data system generates training data focused on inferring user intent in document-grounded dialogue. Accordingly, the generative training data system provides improved flexibility across various domains while also remaining grounded in the context of a digital document for prompt-response interaction.

The generative training data system also improves efficiency relative to conventional systems. Specifically, by circumventing the computational expense of generating human-labeled conversations as training data, the generative training data system requires a considerably smaller amount of time and many fewer participant devices to generate an actionable quantity of robust training data. The computational savings of reducing the number of participant devices is even more pronounced in cases for training across multiple domains because, unlike prior systems, the generative training data system does not need to generate a new set of human-labeled conversation data for each separate instance (or domain) of training.

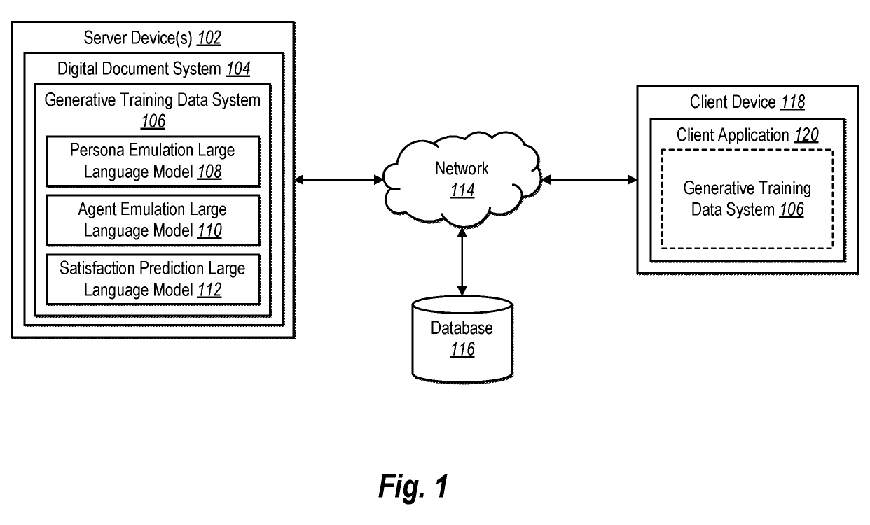

Additional detail regarding the generative training data system 106 will now be provided with reference to the figures. For example, FIG. 1 illustrates a schematic diagram of an example system environment for implementing a generative training data system 106 in accordance with one or more embodiments. An overview of the generative training data system 106 is described in relation to FIG. 1. Thereafter, a more detailed description of the components and processes of the generative training data system 106 is provided in relation to the subsequent figures.

As shown, the environment includes server device(s) 102, a database 116, a network 114, and a client device 118. Each of the components of the environment communicate via the network 114, and the network 114 is any suitable network over which computing devices communicate.

As mentioned, the environment includes a client device 118. The client device 118 is one of a variety of computing devices, including a smartphone, a tablet, a smart television, a desktop computer, a laptop computer, a virtual reality device, an augmented reality device, or another computing device. The client device 118 communicates with the server device(s) 102 via the network 114. For example, the client device 118 provides information to server device(s) 102 indicating client device interactions (e.g., selecting a digital document) and receives information from the server device(s) 102 such as digital documents. Thus, in some cases, the generative training data system 106 on the server device(s) 102 provides and receives information based on client device interaction via the client device 118.

As shown in FIG. 1, the client device 118 includes a client application 120. In particular, the client application 120 is a web application, a native application installed on the client device 118 (e.g., a mobile application, a desktop application, etc.), or a cloud-based application where all or part of the functionality is performed by the server device(s) 102. Based on instructions from the client application 120, the client device 118 presents or displays information to a user. In some cases, the client device 118 includes a version of the generative training data system 106.

As illustrated in FIG. 1, the environment includes the server device(s) 102. The server device(s) 102 generates, tracks, stores, processes, receives, and transmits electronic data, such as digital documents, synthetic prompts, synthetic responses, synthetic personas, conversational goals, information data objects, and satisfaction labels. The server device(s) 102, for example, receives data from the client device 118 in the form of an indication of a client device interaction (e.g., a digital document) to generate a training dataset from the client device interaction. In response, the server device(s) 102 transmits data to the client device 118 to display or present a training dataset based on the client device interaction.

In some embodiments, the server device(s) 102 communicates with the client device 118 to transmit and/or receive data via the network 114, including client device interactions, digital documents, and/or other data. In some embodiments, the server device(s) 102 comprises a distributed server where the server device(s) 102 includes a number of server devices distributed across the network 114 and located in different physical locations. The server device(s) 102 comprise a content server, an application server, a communication server, a content editing server, a web-hosting server, a multidimensional server, and/or a machine learning server. The server device(s) 102 further access and utilize the database 116 to store and retrieve information such as digital documents, synthetic prompts or responses, all or part of the persona emulation LLM 108, all or part of the agent emulation LLM 110, all or part of the satisfaction prediction LLM 112, and/or other data.

In some cases, a large language model (“LLM”) refers to a neural network architecture trained to perform computer tasks to generate or identify computing code and/or data in response to prompts. In particular, a large language model can be a neural network (e.g., a deep neural network) with many (e.g., billions of) parameters trained on large quantities of data (e.g., unlabeled text) using a particular learning technique (e.g., self-supervised learning). For example, a large language model can include parameters trained to understand and generate text analogous to human text, such as synthetic prompts, synthetic responses, satisfaction labels, information data objects, and/or conversational goals. In one or more embodiments, LLMs use large datasets to analyze and predict language patterns to perform tasks like translation, summarization, and conversation. Further, in some embodiments, LLMs are built in a deep learning framework with many parameters to allow them to infer meaning, enabling sophisticated interactions across various domains.

Relatedly, in some embodiments, a neural network includes or refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., synthetic prompts, synthetic responses, satisfaction labels, information data objects, and/or conversational goals) based on a plurality of inputs provided to the neural network. In some cases, a neural network refers to an algorithm (or a set of algorithms) that implements deep learning techniques to model high-level abstractions in data. A neural network can include various layers such as an input layer, one or more hidden layers, and an output layer that each perform tasks for processing data. For example, a neural network can include a deep neural network a convolutional neural network, a recurrent neural network (e.g., an LSTM), a graph neural network, or a large language model.

As further shown in FIG. 1, the server device(s) 102 also includes the generative training data system 106 as part of a digital document system 104. For example, in one or more implementations, the digital document system 104 is able to store, generate, modify, edit, enhance, provide, distribute, and/or share digital documents. For example, the digital document system 104 provides tools for the client device 118, via the client application 120, to view and interact with digital documents using a conversational generative model (e.g., an agent AI) trained on a synthetic training data set generated using the persona emulation LLM 108, the agent emulation LLM 110, and the satisfaction prediction LLM 112.

In one or more embodiments, the server device(s) 102 includes all, or a portion of, the generative training data system 106. For example, the generative training data system 106 operates on the server device(s) 102 to generate and provide a training dataset. In some cases, the generative training data system 106 utilizes, locally on the server device(s) 102 or from another network location (e.g., the database 116), the persona emulation LLM 108, the agent emulation LLM 110, and the satisfaction prediction LLM 112 to generate a training dataset.

In certain cases, the client device 118 includes all or part of the generative training data system 106. For example, the client device 118 generates, obtains (e.g., downloads), or utilizes one or more aspects of the generative training data system 106 from the server device(s) 102. Indeed, in some implementations, as illustrated in FIG. 1, the generative training data system 106 is located in whole or in part on the client device 118. For example, the generative training data system 106 includes a web hosting application that allows the client device 118 to interact with the server device(s) 102. To illustrate, in one or more implementations, the client device 118 accesses a web page supported and/or hosted by the server device(s) 102.

In one or more embodiments, the client device 118 and the server device(s) 102 work together to implement the generative training data system 106. For example, in some embodiments, the server device(s) 102 train one or more LLMs (e.g., the persona emulation LLM 108, the agent emulation LLM 110, and the satisfaction prediction LLM 112) discussed herein and provide the one or more LLMs to the client device 118 for implementation. In some embodiments, the client device 118 attaches a digital document, the server device(s) 102 generates the training dataset, and the client device 118 presents the training dataset. Furthermore, in some implementations, the client device 118 assists in generating the training dataset.

Although FIG. 1 illustrates a particular arrangement of the environment, in some embodiments, the environment has a different arrangement of components and/or may have a different number or set of components altogether. For instance, as mentioned, the generative training data system 106 is implemented by (e.g., located entirely or in part on) the client device 118. In addition, in one or more embodiments, the client device 118 communicates directly with the generative training data system 106, bypassing the network 114. Further, in some embodiments, the persona emulation LLM 108, the agent emulation LLM 110, and the satisfaction prediction LLM 112 include one or more components stored in the database 116, maintained by the server device(s) 102, the client device 118, or a third-party device.

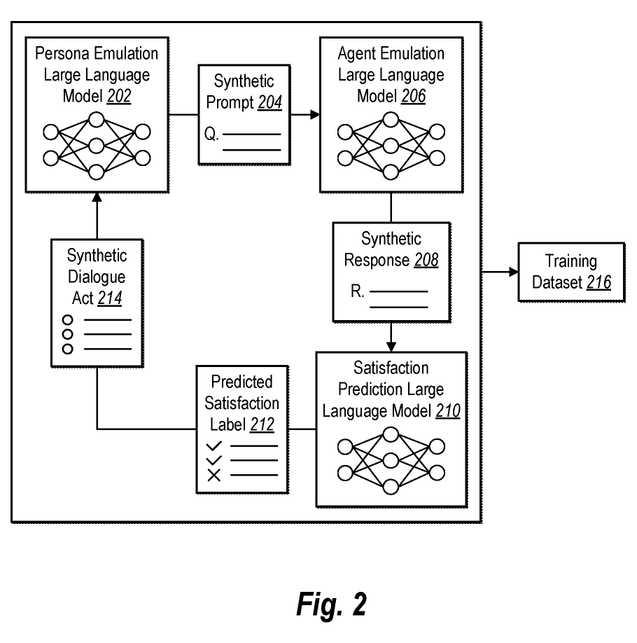

As mentioned, in one or more embodiments, the generative training data system 106 generates a training dataset by using a framework of LLMs to simulate multi-turn conversations. FIG. 2 illustrates an overview of generating a training dataset by using a persona emulation LLM, an agent emulation LLM, and a satisfaction prediction LLM in accordance with one or more embodiments. Additional detail regarding the various acts and processes mentioned with respect to FIG. 2 is provided thereafter with respect to subsequent figure.

As illustrated in FIG. 2, the generative training data system 106 utilizes a persona emulation LLM 202 to generate a synthetic prompt 204. In particular, the generative training data system 106 prompts the persona emulation LLM 202 with information relating to a synthetic persona to generate the synthetic prompt 204, such that the synthetic prompt 204 emulates or resembles a prompt that a user would provide in relation to a digital document. In one or more embodiments, the generative training data system 106 prompts the persona emulation LLM 202 with one or more of a synthetic persona, a conversational goal, and/or an information data object to simulate a user providing a prompt relating to a digital document correlating to their goals and information needs.

As further illustrated in FIG. 2, the generative training data system 106 prompts the persona emulation LLM 202 with the purpose of generating the synthetic prompt 204. In particular, the synthetic prompt 204 emulates a prompt that a user would provide to an AI agent. In one or more embodiments, the synthetic prompt 204 is a query about information contained in a digital document. In some embodiments, the synthetic prompt 204 is a request for a summary of part or all of a digital document.

In some cases, a synthetic prompt refers to a prompt generated by a persona emulation LLM 108 emulating a statement, request, or question posed by a user (via the client device 118) to an AI agent. In some embodiments, a synthetic prompt emulates an prompt posed by a user regarding a specific digital document. For example, a synthetic prompt may include a request for a summary of a digital document, a question about a digital document, or a question about how the digital document applies to a situation facing a user.

As further illustrated in FIG. 2, the generative training data system 106 utilizes an agent emulation LLM 206 to generate a synthetic response 208. In particular, the generative training data system 106 prompts the agent emulation LLM 206 with a response prompt (e.g., the synthetic prompt 204) to generate the synthetic response 208, which emulates a prompt that an AI agent would provide to a user prompt regarding a digital document. In one or more embodiments, the generative training data system 106 prompts the agent emulation LLM 206 with one or more of the digital document and the synthetic prompt 204 to simulate an AI agent responding to a user prompt based on the user prompt relating to a digital document and the associated digital document. For example, in conjunction with the synthetic prompt 204, the generative training data system 106 utilizes the digital document as a knowledge source for data retrieval accessible by the agent emulation LLM 206. In some cases, the generative training data system 106 provides all or a portion of (the text from) the digital document (or a summary of the digital document) to the agent emulation LLM 206 as part of the synthetic prompt 204.

As further illustrated in FIG. 2, the generative training data system 106 prompts the agent emulation LLM 206 to generate the synthetic response 208. In particular, the generative training data system 106 generates the synthetic response 208 to emulate a response that an AI agent would provide to a user in response to a prompt. In one or more embodiments, the synthetic response 208 is a response to a query about information contained in a digital document. In some embodiments, the synthetic response 208 is a summary of part or all of a digital document in response to a summary request.

In some cases, a synthetic response refers to a response generated by an agent emulation LLM 110 in response to a synthetic prompt. For instance, a synthetic response emulates or simulates a response or statement generated by an AI agent in response to a prompt from the client device 118. In some embodiments, a synthetic response emulates a response generated by an AI agent in response to an prompt regarding a digital document. Indeed, the agent emulation LLM 110 generates the synthetic response based on predicted or inferred goals and purposes associated with the synthetic prompt. For example, a synthetic response may include a summary of a digital document or a response to a question about the digital document.

As further illustrated in FIG. 2, the generative training data system 106 utilizes a satisfaction prediction LLM 210 to generate a predicted satisfaction label 212. In particular, the generative training data system 106 prompts the satisfaction prediction LLM 210 with the synthetic prompt 204 and the synthetic response 208 to generate the predicted satisfaction label 212 to indicate a prediction of how well the synthetic response 208 addresses, answers, or fulfills the synthetic prompt 204. In one or more embodiments, the generative training data system 106 prompts (or provides to) the satisfaction prediction LLM 210 with one or more of the synthetic prompt 204, the synthetic response 208, an information data object, a conversational goal, and a digital document to evaluate the suitability of the synthetic response 208 to the synthetic prompt 204.

As further illustrated in FIG. 2, the generative training data system 106 prompts the satisfaction prediction LLM 210 with the purpose of generating the predicted satisfaction label 212. In particular, the generative training data system 106 generates the predicted satisfaction label 212 to represent the suitability of the synthetic response 208 to the synthetic prompt 204. In one or more embodiments, the generative training data system 106 generates the predicted satisfaction label 212 by randomly focusing on the synthetic prompt 204, the information data object, or the conversational goal and evaluating the suitability of the synthetic response 208.

In some cases, a satisfaction label refers to a label generated by a satisfaction prediction LLM 112 indicating the suitability of the synthetic response to the synthetic prompt. For example, a satisfaction label includes a semantic label selected from among a set of candidate labels, such as “satisfied,” “dissatisfied,” and “partially satisfied.” In one or more embodiments, a satisfaction label is generated by randomly focusing on either the synthetic prompt, the concept the synthetic prompt is associated with (e.g., the information data object), or the high-level goal of the synthetic persona (e.g., the conversational goal). Further, in some embodiments, a satisfaction label is determined by prompting the satisfaction prediction LLM with the conversation history, the information data object, the conversational goal, and the digital document.

As further illustrated in FIG. 2, the generative training data system 106 utilizes the predicted satisfaction label 212 to select a synthetic dialogue act 214. In particular, the generative training data system 106, based on the predicted satisfaction label 212, randomly samples from a set of discrete dialogue acts to select the synthetic dialogue act 214. In one or more embodiments, the generative training data system 106 selects the synthetic dialogue act 214 to further prompt the persona emulation LLM 202 to generate a subsequent synthetic prompt or terminate the conversation regarding the digital document. In some embodiments, the generative training data system 106 selects the synthetic dialogue act from a set of sample dialogue acts (e.g., Compliment, Follow Up, Shift Topics, Exit, Paraphrase Question, Ask More Specific Question, Breakdown Question, Negative Feedback and Revise Question, Ask for More Details, Follow Up Question).

As further illustrated in FIG. 2, the generative training data system 106 generates a training dataset 216. In particular, the generative training data system 106 generates the training dataset 216 by iteratively repeating the process of generating synthetic prompts and corresponding synthetic responses as part of a multi-turn conversation. Indeed, the generative training data system 106 generates multiple turns of prompt-response pairs based on a predicted satisfaction label and a synthetic dialogue act at each turn/iteration. In one or more embodiments, the generative training data system 106 thus generates the training dataset 216 to include many multi-turn conversations across many domains and/or relating to many different documents, synthetic personas, and conversational goals. Indeed, the generative training data system 106 generates the training dataset 216 by modeling a conversation between a user and an AI agent through generating iterative prompts and responses between the agent emulation LLM 206 and the satisfaction prediction LLM 210. Further, in one or more embodiments, the generative training data system 106 generates the training dataset 216 to evaluate the performance of existing machine learning models in predicting user satisfaction in multi-turn conversations. For example, the generative training data system 106 generates the training dataset 216 to evaluate the performance of untrainable machine learning models in predicting user satisfaction in multi-turn conversations.

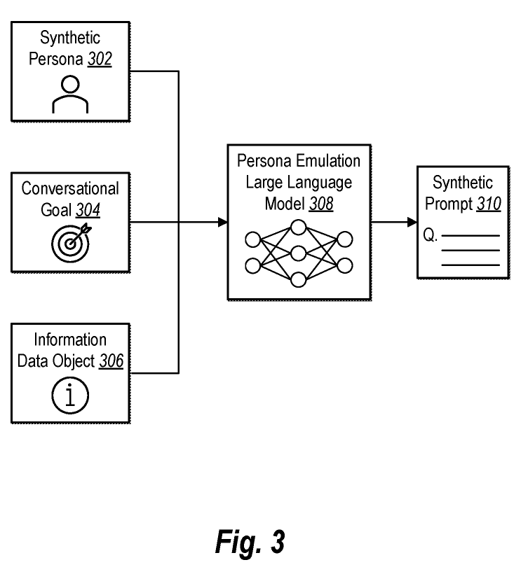

As mentioned, in one or more embodiments, the generative training data system 106 generates a synthetic prompt utilizing a persona emulation LLM. FIG. 3 illustrates a diagram of utilizing a persona emulation large language model to generate a synthetic prompt in accordance with one or more embodiments. Additional detail regarding the various acts and processes mentioned with respect to FIG. 3 is provided thereafter with respect to subsequent figures.

As illustrated in FIG. 3, the generative training data system 106 generates a synthetic persona 302. In particular, the generative training data system 106 generates the synthetic persona 302 to emulate a user account conversing with an AI agent. In one or more embodiments, the generative training data system 106 generates the synthetic persona 302 by defining one or more user aspects, characteristics, or attributes to simulate the background of a user. In one or more embodiments, the generative training data system 106 defines one or more aspects of the synthetic persona 302, such as a binary indication of a professionalism aspect (i.e., is the user account a student or a professional), a binary indication of an expertise characteristic (i.e., is the user account a novice or an expert in the topic discussed), or a binary indication of reading detail characteristic (i.e., is the user account reading for depth or for breadth).

In some cases, a synthetic persona refers to a synthesized, simulation version of a user account. For example, a synthetic persona is made up of background data indicating characteristics or attributes of a user account. In some cases, a synthetic persona includes data generated for a persona emulation LLM to emulate a user account conversing with an AI agent. Example attributes or characteristics of a synthetic persona include (binary) indications of a professional level of the user account, an expertise of the user account, or whether the user account is reading for depth or for breadth.

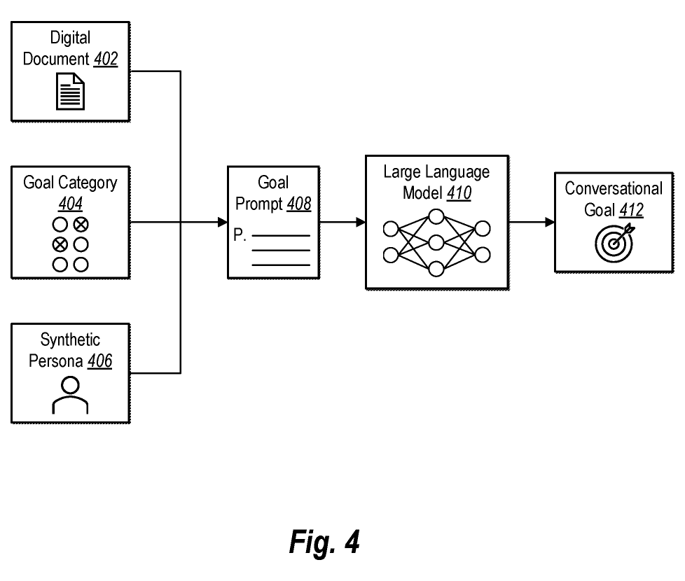

As further illustrated in FIG. 3, the generative training data system 106 generates a conversational goal 304. In particular, the generative training data system 106 generates the conversational goal 304 to simulate the goals of a user conversing with an AI agent about a digital document. More information on the generation of the conversational goal 304 is provided in FIG. 4.

In some cases, a conversational goal refers to a text description of a goal or purpose of a user account (or a synthetic persona) interacting with a digital document. In one or more embodiments, a conversational goal is selected from among several goal categories and is consistent with the synthetic persona and the digital document. For example, for a non-expert professional reading a paper about Casimir force calculations, the conversational goal would be a paragraph summarizing the content of the document. In some cases, a conversational goal can be broken up or divided into discrete concepts that together make up the overall conversational goal and/or can be related to a set of concepts that inform the conversational goal.

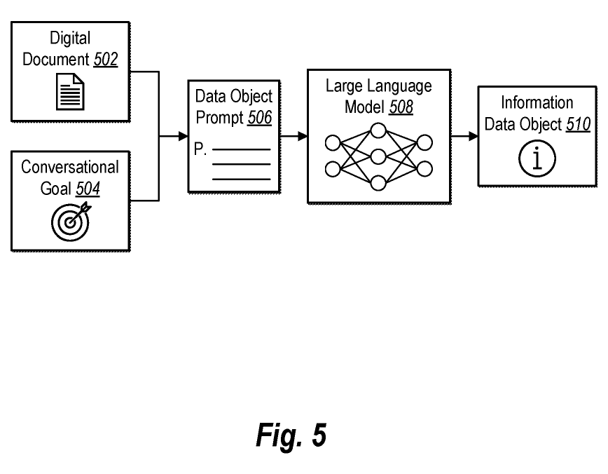

As further illustrated in FIG. 3, the generative training data system 106 generates an information data object 306. In particular, the generative training data system 106 generates the information data object 306 to simulate the information that a user is seeking in a conversation with an AI agent about a digital document based on the conversational goal 304. More information on the generation of the information data object 306 is provided in FIG. 5.

In some cases, an information data object refers to a digital object or data segment derived from a conversational goal and defining (a set of) specific concepts in the digital document. For example, the information data object defines a set of three concepts relevant to a conversational goal and formats them as sub-objects. In some cases, an information data object also includes a set of questions corresponding to the sub-objects of the conversational goal. For instance, an information data object associated with a conversational goal related to Casimir force calculations would include sub-objects related to the goal (e.g., understanding the basics of Casimir force, exploring the controversies of model application, and assessing theoretical discrepancies and their impacts) and questions related to the sub-objects, with the information data object formatted as a JSON object.

As further illustrated in FIG. 3, the generative training data system 106 utilizes a persona emulation LLM 308 to generate a synthetic prompt 310. In particular, the generative training data system 106 prompts or provides the persona emulation LLM 308 with the synthetic persona 302, the conversational goal 304, and the information data object 306. In one or more embodiments, the generative training data system 106 prompts the persona emulation LLM 308 with a sub-object randomly selected from the information data object 306, with the sub-object constituting a code segment encompassing a portion of the overall information data object. In one or more embodiments, the generative training data system 106 randomly selects the sub-object based on the context of the synthetic persona 302 and the conversational goal 304. In some embodiments, the generative training data system 106 utilizes the sub-object selected from the information data object 306 to generate the synthetic prompt 310.

As further illustrated in FIG. 3, the generative training data system 106 generates a synthetic prompt 310. In particular, the generative training data system 106 generates the synthetic prompt 310 to emulate a prompt that a user would provide in a conversation with an AI agent. In one or more embodiments, the generative training data system 106 generates the synthetic prompt 310 to emulate a question a user would ask an AI agent specifically about a digital document.

In some embodiments, the generative training data system 106 modifies the synthetic prompt 310 by using a rephrasing prompt to cause the synthetic prompt 310 to more naturally emulate a user. In one or more embodiments, the generative training data system 106 prompts an LLM with the rephrasing prompt instructing the LLM to alter the synthetic prompt 310. In some embodiments, the generative training data system 106 generates the rephrasing prompt to instruct the LLM to rewrite the synthetic prompt 310 in a style more akin to a user prompt.

In one or more embodiments, the generative training data system 106 modifies the synthetic prompt 310 by inserting one or more references to previous conversation text to cause the synthetic prompt 310 to more naturally emulate a user. In some embodiments, the generative training data system 106 inserts one or more pronouns referring to previous conversation text. In one or more embodiments, the generative training data system 106 inserts one or more references to a prior prompt or response.

As mentioned, in one or more embodiments, the generative training data system 106 generates a conversational goal for use in generating a synthetic prompt. FIG. 4 illustrates an overview of generating a conversational goal from a digital document, a goal category, and a synthetic persona in accordance with one or more embodiments.

As illustrated in FIG. 4, the generative training data system 106 identifies and processes a digital document 402. In particular, the generative training data system 106 identifies the digital document 402 as the source or subject of a multi-turn conversation with an AI agent. In one or more embodiments, the generative training data system 106 processes the digital document 402 to determine or extract data from the digital document 402. The generative training data system 106 extracts data such as topics, mentioned entities, images, author, permission level, and other data (and/or metadata) included in (or associated with) the digital document 402. In some cases, the generative training data system 106 process the digital document 402 by generating a summary of the digital document 402.

As further illustrated in FIG. 4, the generative training data system 106 selects or determines a goal category 404. In particular, the generative training data system 106 selects the goal category 404 to emulate the goals of a user conversing with an AI agent. In one or more embodiments, the generative training data system 106 selects the goal category 404 by selecting the goal category 404 from among a fixed set of goal categories (pre-generated and stored in a database, such as the database 116). In some embodiments, the generative training data system 106 selects the goal category 404 from among candidate goal categories such as “assess impact of new information on my organization,” “analyze the document for relevance to Project X,” or “ensure the document is accurate and trustworthy.”

As further illustrated in FIG. 4, the generative training data system 106 generates a synthetic persona 406. In particular, the generative training data system 106 generates the synthetic persona 406 to emulate a user account in conversation with an AI agent. In one or more embodiments, the generative training data system 106 generates the synthetic persona 406 by defining one or more user aspects to simulate the background of a user. In one or more embodiments, the generative training data system 106 defines one or more aspects of the synthetic persona 406, such as a binary professionalism aspect (i.e., is the user a student or a professional), a binary expertise characteristic (i.e., is the user a novice or an expert in the topic discussed), and a binary reading detail characteristic (i.e., is the user reading for depth or for breadth). Indeed, the generative training data system 106 generates the synthetic persona 406 to include a binary indication of each of the three aforementioned aspects or characteristics. By modifying the binary indications of the characteristics, the generative training data system 106 thus generates new synthetic personas.

As further illustrated in FIG. 4, the generative training data system 106 processes the digital document 402, the goal category 404, and the synthetic persona 406 to generate a goal prompt 408. In some embodiments, the generative training data system 106 generates text consistent with the information in the digital document 402, the goal category 404, and the synthetic persona 406 as well as instructions to prompt an LLM (i.e., the large language model 410) to generate a conversational goal (i.e., the conversational goal 412). In particular, the generative training data system 106 generates the goal prompt 408 to prompt responses to specific scenarios consistent with the digital document 402, the goal category 404, and the synthetic persona 406. In one or more embodiments, the generative training data system 106 generates the goal prompt 408 to prompt the generation of a high-level goal summary text and a more detailed description of the goal.

As further illustrated in FIG. 4, the generative training data system 106 processes the goal prompt 408 through a large language model 410 to generate a conversational goal 412. In particular, the generative training data system 106 passes the goal prompt 408 into the large language model 410 to generate specific scenarios consistent with the digital document 402, the goal category 404, and the synthetic persona 406. For example, in one or more embodiments, the generative training data system 106, when utilizing a digital document 402 titled Casimir force calculations near the insulator-conductor transition in gold thin films, a goal category 404 of “to review the content in the document and enhance it,” and a synthetic persona 406 of a non-expert professional reading for depth, utilizes the large language model 410 to generate one or more specific scenarios consistent with the digital document 402, the goal category 404, and the synthetic persona 406. In one or more embodiments, the generative training data system 106 passes the goal prompt 408 into the large language model 410 to generate the conversational goal 412, with the conversational goal 412 consistent with the specific scenarios generated by the large language model 410.

As further illustrated in FIG. 4, the generative training data system 106 selects one of the specific scenarios generated by the large language model 410 as the conversational goal 412. In particular, the generative training data system 106 generates the conversational goal 412 to emulate the goals of a user conversing with an AI agent. In some embodiments, the generative training data system 106 generates the conversational goal 412 to describe the goal category 404 (e.g., to review the content in the document and enhance it) of the synthetic persona 406 (e.g., a non-expert professional reading for depth) regarding the digital document 402 (e.g., an academic paper titled Casimir force calculations near the insulator-conductor transition in gold thin films). In one or more embodiments, the generative training data system 106 generates the conversational goal 412 as a plain text high-level goal summary (e.g., “Addressing Controversies and Theoretical Discrepancies”) and a more detailed description of the user’s goal (e.g., “The document mentions controversies surrounding the application of different models (Drude vs. Plasma) to predict the Casimir force, notably the violation of Nernst’s heat theorem. This task involves compiling arguments from both sides of the debate, with the aim of presenting a balanced view on the matter. The desired outcome is to provide a comprehensive understanding of the underlying issues, fostering informed discussions among professionals. By acknowledging and critically assessing these controversies, the document will contribute to advancing theoretical developments and potentially pave the way for resolving longstanding questions in Casimir physics”).

As mentioned, in one or more embodiments, the generative training data system 106 generates an information data object for use in generating a synthetic prompt. FIG. 5 illustrates an overview of generating an information data object from a digital document and a conversational goal in accordance with one or more embodiments.

As illustrated in FIG. 5, the generative training data system 106 identifies and processes a digital document 502. In particular, the generative training data system 106 identifies the digital document 502 as a source or subject of a multi-turn conversation. In one or more embodiments, the generative training data system 106 processes the digital document 502 by performing one or more of attaching the entirety of the digital document 502 to a prompt, designating the digital document 502 as a knowledge source accessible by an LLM, generating a summary of the digital document 502, or extracting a set of textual features from the digital document 502.

As further illustrated in FIG. 5, the generative training data system 106 generates a conversational goal 504. In particular, the generative training data system 106 generates the conversational goal 504 as a description of a goal or purpose of conversing with an AI agent. In one or more embodiments, the generative training data system 106 generates the conversational goal 504 as a plain text description and/or summary. In these or other embodiments, the generative training data system 106 generates the conversational goal 504 to also include a more detailed description of an intent or purpose for conversing with an AI agent.

As further illustrated in FIG. 5, the generative training data system 106 utilizes the digital document 502 and the conversational goal 504 to generate a data object prompt 506. In particular, the generative training data system 106 generates the data object prompt 506 as a combination of the digital document 502 and the conversational goal 504. For instance, the data object prompt 506 includes a summary of the digital document 502 and/or an instruction to access the digital document 502 as a knowledge source. Accordingly, the data object prompt 506 instructs a large language model 508 to generate an information data object 510. In some cases, the information data object 510 is a digital object (e.g., a Java Script Object Notation or JSON object) representing concepts and questions correlating with the digital document 502 and the conversational goal 504. In one or more embodiments, the generative training data system 106 generates the data object prompt 506 by combining features or information extracted from the digital document 502 and the conversational goal 504.

As further illustrated in FIG. 5, the generative training data system 106 processes the data object prompt 506 through a large language model 508 to generate an information data object 510. In particular, the information data object 510 is a digital object (e.g., a JSON object) representing the concepts that are relevant to a user’s goal when conversing with an AI agent. In one or more embodiments, the information data object 510 includes a set of sub-objects representing concepts discussed in a digital document (e.g., the digital document 502) relevant to a user’s goal (e.g., the conversational goal 504). For example, in one or more embodiments, if the digital document 502 is an academic paper titled Casimir force calculations near the insulator-conductor transition in gold thin films and the conversational goal 504 is “Addressing Controversies and Theoretical Disputes,” the generative training data system 106 generates the information data object 510 with sub-objects such as “Understanding the Basics of Casimir Force,” “Exploring the Controversies of Model Application,” and “Assessing Theoretical Discrepancies and Their Impacts.”

In some embodiments, the information data object 510 includes a list of example questions answerable by a digital document (e.g., the digital document 502) to achieve a user’s goal (e.g., the conversational goal 504). For example, in one or more embodiments, if the digital document 502 is an academic paper titled Casimir force calculations near the insulator-conductor transition in gold thin films and the conversational goal 504 is “Addressing Controversies and Theoretical Disputes,” the generative training data system 106 generates the information data object 510 to include questions such as “What is the Casimir force and how is it calculated?,” “What are the main points of contention between supporters of the Drude and Plasma models?,” and “In what ways do the theoretical discrepancies between the Drude and Plasma models affect the study of Casimir physics?.”

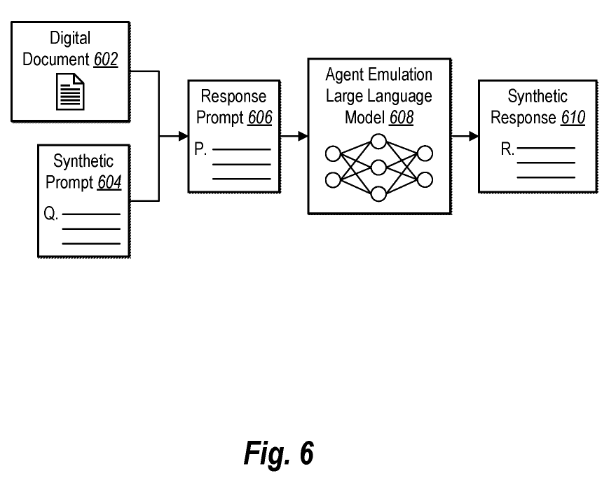

As mentioned, in one or more embodiments, the generative training data system 106 generates a synthetic response to a synthetic prompt. FIG. 6 illustrates an overview of generating a synthetic response from a synthetic prompt by utilizing an agent emulation large language model in accordance with one or more embodiments.

As illustrated in FIG. 6, the generative training data system 106 processes a digital document 602. In particular, the generative training data system 106 processes the digital document 602 as part of emulating a multiturn conversation with an AI agent.

As further illustrated in FIG. 6, the generative training data system 106 processes the synthetic prompt 604. In particular, the synthetic prompt 604 emulates a prompt from a user in a conversation with an AI agent generated by a persona emulation LLM (e.g., the persona emulation LLM 308) based on a synthetic persona (e.g., the synthetic persona 302), a conversational goal (e.g., the conversational goal 304), and an information data object (e.g., the information data object 306). In one or more embodiments, the synthetic prompt 604 represents a question a user would ask an AI agent about a digital document.

As further illustrated in FIG. 6, the generative training data system 106 generates a response prompt 606 by processing the digital document 602 and the synthetic prompt 604. In particular, the generative training data system 106 generates the response prompt 606 by combining the digital document 602 and the synthetic prompt 604. In some embodiments, the generative training data system 106 combines the digital document 602 and the synthetic prompt 604 by prompting the agent emulation LLM 608 to access the digital document 602 in response to the synthetic prompt 604. In one or more embodiments, the generative training data system 106 combines the digital document 602 and the synthetic prompt 604 by appending the digital document 602 to the synthetic prompt 604. Further, in some embodiments, the generative training data system 106 generates the response prompt 606 by performing one or more of attaching the entirety of the digital document 602, generating a summary of the digital document 602, or extracting a set of textual features from the digital document 602.

As further illustrated in FIG. 6, the generative training data system 106 feeds the response prompt 606 into an agent emulation LLM 608 to generate a synthetic response 610. In particular, the generative training data system 106 utilizes the agent emulation LLM 608 to emulate an AI agent conversing with a user about the digital document 602. In some embodiments, the generative training data system 106 utilizes the agent emulation LLM 608 to emulate an AI agent by providing the agent emulation LLM 608 with the response prompt 606 containing the digital document 602 and the synthetic prompt 604 to emulate an AI agent responding to an prompt from a user with the only context being the document in question (e.g., the digital document 602) and the prompt from the user (e.g., the synthetic prompt 604).

As further illustrated in FIG. 6, the generative training data system 106 generates a synthetic response 610. In particular, the generative training data system 106 generates the synthetic response 610 to emulate the response of an AI agent to a prompt from a user. For example, in some embodiments, the generative training data system 106 generates the synthetic response 610 to answer a question posed in the synthetic prompt 604 about the digital document 602. In one or more embodiments, the generative training data system 106 generates the synthetic response 610 as a summary of the digital document 602 based on a request in the synthetic prompt 604 In one or more embodiments, the generative training data system 106 generates the synthetic response 610 based on an entire conversation history in addition to the synthetic prompt 604.

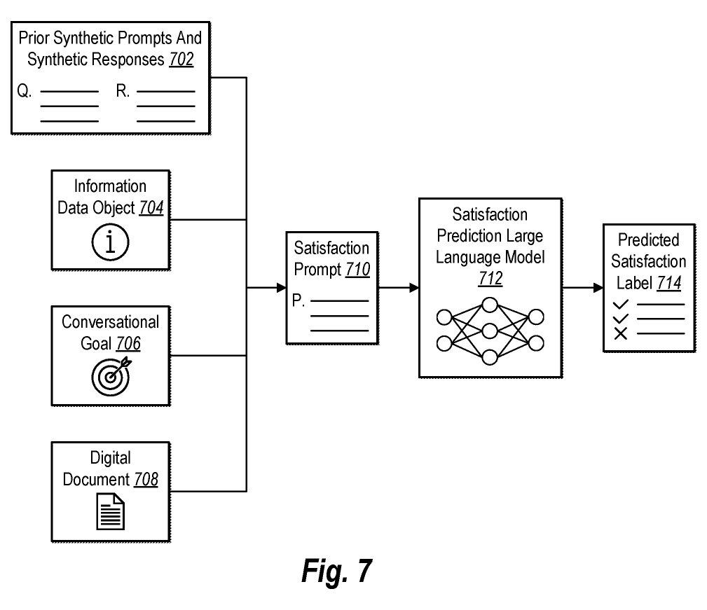

As mentioned, in one or more embodiments, the generative training data system 106 generates a predicted satisfaction label reflecting the suitability of a synthetic response (e.g., how well a synthetic response matches, resolves, answers, or relates to a synthetic prompt). FIG. 7 illustrates an overview of generating a predicted satisfaction label from a satisfaction prompt in accordance with one or more embodiments. Additional detail regarding the various acts and processes mentioned with respect to FIG. 7 is provided thereafter with subsequent figures.

As illustrated in FIG. 7, the generative training data system 106 processes prior synthetic prompts and synthetic responses 702. In particular, the generative training data system 106 processes prior synthetic prompts and synthetic responses 702 to simulate a multi-turn conversation between a user and an AI agent about a digital document (e.g., the digital document 708). In some embodiments, the generative training data system 106 generates prior synthetic prompts and synthetic responses 702 by iteratively prompting a persona emulation LLM (e.g., the persona emulation LLM 308) and an agent emulation LLM (e.g., the agent emulation LLM 608) to simulate a multi-turn conversation between a user and an AI agent. The generative training data system 106 further stores the prior synthetic prompts and synthetic responses 702 to inform subsequent iterations of a multi-turn conversation. In some embodiments, the generative training data system 106 uses the immediately prior conversation turn (e.g., a prompt-response pair), while in other cases the generative training data system 106 uses the immediately prior turn in addition to one or more turns previous to that.

As further illustrated in FIG. 7, the generative training data system 106 generates an information data object 704. In particular, the generative training data system 106 generates the information data object 704 to simulate the information that a user is seeking in a conversation with an AI agent about a digital document. More information on the generation of the information data object 704 is provided in FIG. 5.

As further illustrated in FIG. 7, the generative training data system 106 generates a conversational goal 706. In particular, the generative training data system 106 generates the conversational goal 706 to simulate the goals of a user conversing with an AI agent about a digital document. More information on the generation of the conversational goal 706 is provided in FIG. 4.

As further illustrated in FIG. 7, the generative training data system 106 processes a digital document 708. In particular, the generative training data system 106 processes the digital document 708 as part of emulating a multiturn conversation with an AI agent about a specific digital document. In one or more embodiments, the generative training data system 106 instructs an LLM (e.g., the satisfaction prediction LLM 712) to extract textual features from the digital document 708. In some embodiments, the generative training data system 106 generates a summary of the digital document 708 to attach to a prompt (e.g., the satisfaction prompt 710).

As further illustrated in FIG. 7, the generative training data system 106 generates a satisfaction prompt 710. In particular, the generative training data system 106 generates the satisfaction prompt 710 by combining the prior synthetic prompts and synthetic responses 702, the information data object 704, the conversational goal 706, and/or the digital document 708. In one or more embodiments, the generative training data system 106 incorporates the prior synthetic prompts and synthetic responses 702 by including instructions in the satisfaction prompt 710 to include analysis of the prior multiturn conversation. In one or more embodiments, the generative training data system 106 generates the satisfaction prompt 710 with instructions to access the digital document 708. In some embodiments, the generative training data system 106 combines the prior synthetic prompts and synthetic responses 702, the information data object 704, the conversational goal 706, and/or the digital document 708 by concatenating the text within each element. In one or more embodiments, the generative training data system 106 generates the satisfaction prompt 710 by randomly focusing on one or more of the immediate prior synthetic prompt from prior synthetic prompts and synthetic responses 702, the information data object 704, or the conversational goal 706. In some embodiments, the generative training data system generates the satisfaction prompt 710 by randomly focusing on the information data object 704 as the relevant focus of the satisfaction prompt 710.

Using the satisfaction prompt 710, the generative training data system 106 instructs the satisfaction prediction LLM 712 to evaluate the suitability of a synthetic response (e.g., the synthetic response 610) to a synthetic prompt (e.g., the synthetic prompt 310). In some embodiments, the generative training data system 106 instructs the satisfaction prediction LLM 712 to compare the synthetic response (e.g., the synthetic response 610) to the synthetic prompt (e.g., the synthetic prompt 310) according to the information and instructions presented in the satisfaction prompt 710. For instance, in some embodiments, the generative training data system 106 evaluates the suitability of the synthetic response (e.g., the synthetic response 610) to the synthetic prompt (e.g., the synthetic prompt 310) by prompting the satisfaction prediction LLM 712 with the satisfaction prompt 710 and evaluating whether the synthetic response is coherent in the context of the prior synthetic prompts and synthetic responses 702, answers the questions in the information data object 704, is relevant to the conversational goal 706, and is grounded in the digital document 708. In one or more embodiments, the generative training data system 106 utilizes the satisfaction prediction LLM 712 to emulate an observer evaluating whether an AI agent’s response to a user’s prompt is suitable.

As further illustrated in FIG. 7, the generative training data system 106 generates a predicted satisfaction label 714. In one or more embodiments, the generative training data system 106 generates the predicted satisfaction label 714 by emulating the response of a user to whether the synthetic response (e.g., the synthetic response 610) was a suitable response to their prompt (e.g., the synthetic prompt 310). In some embodiments, the predicted satisfaction label 714 is one of “Satisfied,” “Dissatisfied,” or “Partially Satisfied.”

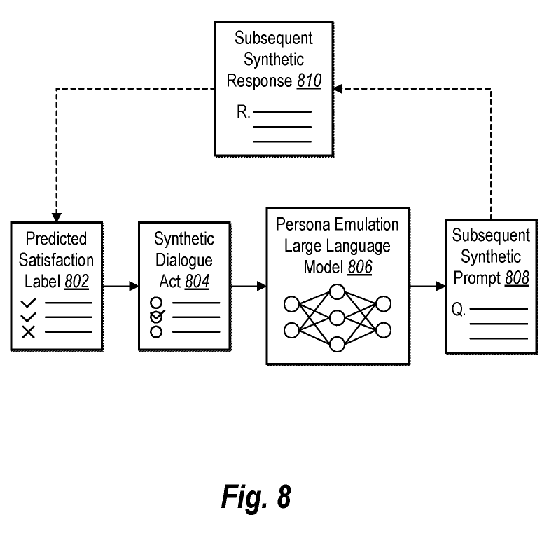

As mentioned, in one or more embodiments, the generative training data system 106 generates a subsequent synthetic prompt. In particular, the generative training data system 106 generates a subsequent synthetic prompt informed by a previous turn in a multi-turn conversation. FIG. 8 illustrates an overview of generating a subset synthetic prompt in accordance with one or more embodiments.

As illustrated in FIG. 8, the generative training data system 106 generates a predicted satisfaction label 802. In particular, the generative training data system 106 generates the predicted satisfaction label 802 to represent the suitability of a synthetic response (e.g., the synthetic response 610) to a synthetic prompt (e.g., the synthetic prompt 310). More information on the generation of the predicted satisfaction label 802 is found in FIG. 7.

As further illustrated in FIG. 8, the generative training data system 106 utilizes the predicted satisfaction label 802 to select a synthetic dialogue act 804. In particular, the generative training data system 106, based on the predicted satisfaction label 802, randomly samples the synthetic dialogue act 804 from a set of candidate dialogue acts. In one or more embodiments, the generative training data system 106 samples the synthetic dialogue act 804 from a set of candidate dialogue acts corresponding to the predicted satisfaction label 802. For instance, the predicted satisfaction label 802 is labeled one of “Satisfied,” “Dissatisfied,” or “Partially Satisfied.” Each of the above labels includes or corresponds to a corresponding set of candidate dialogue acts from which the generative training data system 106 selects.

In some embodiments, the generative training data system 106 (randomly) samples the set of dialogue acts to determine the synthetic dialogue act 804 based on whether the predicted satisfaction label 802 is “Satisfied” (i.e., sampling dialogue acts such as Compliment, Follow Up, Shift Topics, or Exit), “Dissatisfied” (sampling dialogue acts such as Paraphrase Question, Ask More Specific Question, Breakdown Question, Shift Topics, Negative Feedback and Revise Question, or Exit), or “Partially Satisfied” (sampling dialogue acts such as Ask For More Details, Follow Up Question, or Negative Feedback and Follow Up Question).

As further illustrated in FIG. 8, the generative training data system 106 feeds the synthetic dialogue act 804 into a persona emulation LLM 806 to generate a subsequent synthetic prompt 808. In particular, the generative training data system 106 prompts the persona emulation LLM 806 with the synthetic dialogue act 804. In one or more embodiments, the generative training data system 106 utilizes the persona emulation LLM 806 to emulate a user interacting with an AI agent.

As further illustrated in FIG. 8, the generative training data system 106 generates a subsequent synthetic prompt 808. In particular, the generative training data system 106 generates the subsequent synthetic prompt 808 based on the synthetic dialogue act 804. In one or more embodiments, the generative training data system 106 generates the subsequent synthetic prompt 808 in response to a prior synthetic response (e.g., the synthetic response 610).

As further illustrated in FIG. 8, the generative training data system 106 generates a subsequent synthetic response 810 in response to the subsequent synthetic prompt 808. In particular, in some embodiments, the generative training data system 106 generates the subsequent synthetic response 810 in a process analogous to the one depicted in FIG. 6. In one or more embodiments, the generative training data system 106 utilizes the subsequent synthetic response 810 to generate a further predicted satisfaction label to generate further subsequent synthetic prompts iteratively, emulating a multi-turn conversation between a user and an AI agent.

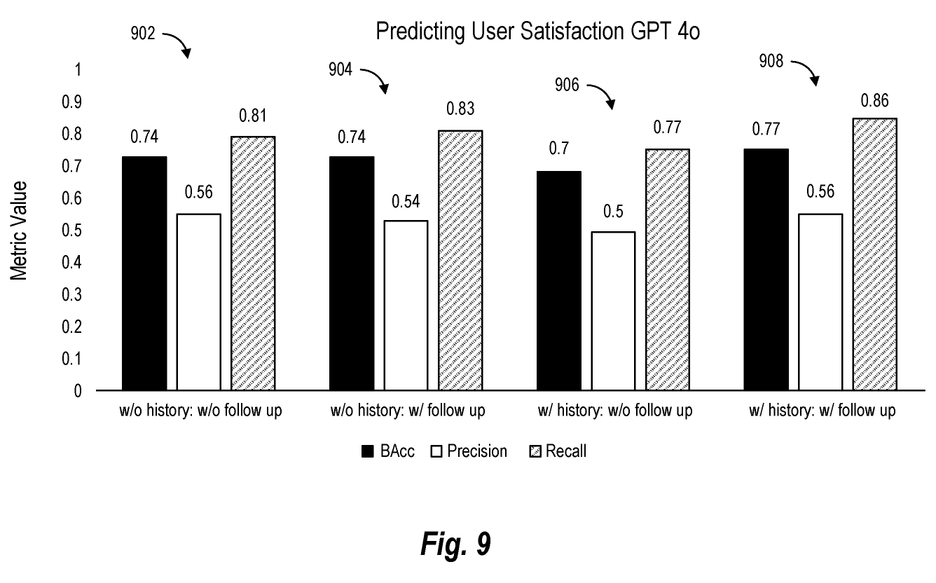

As mentioned, in one or more embodiments, the generative training data system 106 presents several advantages in predicting user satisfaction over existing AI agent training systems. Indeed, experimenters have demonstrated performance of the generative training data system 106. FIG. 9 illustrates a graphical representation of experimental performance metrics of the generative training data system 106 in accordance with one or more embodiments.

As illustrated in FIG. 9, in one or more embodiments, the graph 902 depicts the results of evaluating the ability of the generative training data system 106 to predict user satisfaction without using conversation history (e.g., the prior synthetic prompts and synthetic responses 702) and without follow-up questions (e.g., the subsequent synthetic prompt 808) in three different domains (BAcc, Precision, and Recall) in GPT-4o. In some embodiments, BAcc is a domain used to account for class imbalance in datasets, Precision is a domain used to measure the proportion of true positive predictions relative to false positive predictions, and Recall (or true positive rate0 is a domain used to identify true positive predictions as opposed to false negatives. In some embodiments, the graph 902 function to show a baseline ability of an LLM to predict user satisfaction, as the features of the generative training data system 106 are not fully implemented.

As further illustrated in FIG. 9, in contrast, the bars 904 demonstrate the results of evaluating the ability of the generative training data system 106 to predict user satisfaction without using conversation history but with follow-up questions in the same domains as the graph 902 in GPT-4o. As illustrated, the bars 904 demonstrate no change in the accuracy of the predicted user satisfaction of the BAcc domain, a decrease in the accuracy of the predicted user satisfaction of the Precision domain, and an increase in the accuracy of the predicted user satisfaction of Recall domain as compared to the graph 902.

As further illustrated in FIG. 9, the bars 906 demonstrate the results of evaluating the ability of the generative training data system 106 to predict user satisfaction with using conversation history but without follow-up questions in the same domains as the graph 902 in GPT-4o. As illustrated, the bars 906 demonstrate a decrease in the accuracy of the predicted user satisfaction of the BAcc domain, a decrease in the accuracy of the predicted user satisfaction of the Precision domain, and a decrease in the accuracy of the predicted user satisfaction of the Recall domain as compared to the graph 902.

As further illustrated in FIG. 9, the bars 908 demonstrate the results of evaluating the ability of the generative training data system 106 to predict user satisfaction with using conversation history and follow-up questions in the same domains as the graph 902 in GPT-4o. As illustrated, the bars 908 demonstrate an increase in the accuracy of the predicted user satisfaction of the BAcc domain, no change in the accuracy of the predicted user satisfaction of the Precision domain, and an increase in the accuracy of the predicted user satisfaction of the Recall domain as compared to the graph 902. As illustrated, the generative training data system 106, when fully implemented, shows an improvement in the accuracy of predicting user satisfaction in two of the three domains, with the other domain not decreasing in the accuracy of predicting user satisfaction.

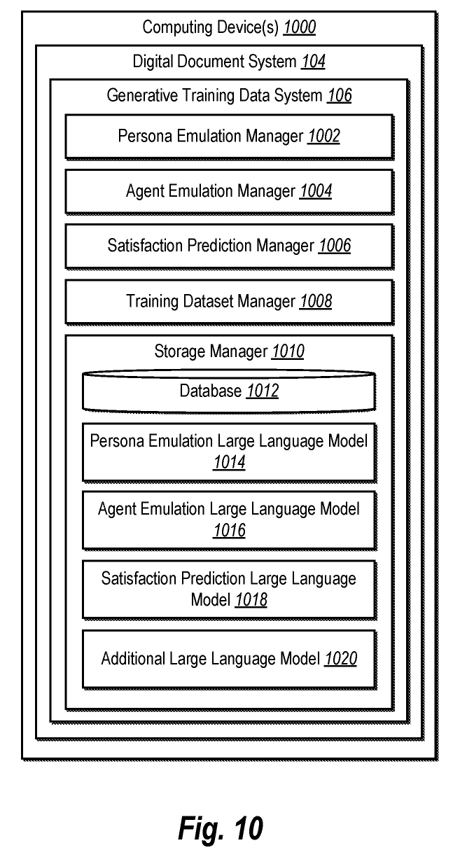

Referring now to FIG. 10, additional detail will be provided regarding components and capabilities of the generative training data system 106. Specifically, FIG. 10 illustrates an example schematic diagram of the generative training data system 106 on an example computing device(s) 1000 (e.g., one or more of the client device 118 and/or the server device(s) 102). As shown in FIG. 10, the generative training data system 106 includes a persona emulation manager 1002, an agent emulation manager 1004, a satisfaction prediction manager 1006, a training dataset manager 1008, and a storage manager 1010.

As mentioned, the generative training data system 106 includes a persona emulation manager 1002. In particular, the persona emulation manager 1002 generates, modifies, alters, or augments a synthetic persona (e.g., the synthetic persona 302) and associated information with the synthetic persona (e.g., the conversational goal 304 and the information data object 306). For example, the persona emulation manager 1002 generates a synthetic persona and associated information to feed into an LLM (e.g., the persona emulation LLM 1014) to generate a synthetic prompt (e.g., the synthetic prompt 310).

As mentioned, the generative training data system 106 includes an agent emulation manager 1004. In particular, the agent emulation manager 1004 generates, modifies, alters, or augments an agent emulation system and associated information with the synthetic agent (e.g., the digital document 602 and the synthetic prompt 604). For example, the agent emulation manager 1004 processes a digital document and a synthetic prompt through an LLM (e.g., the agent emulation LLM 1016) to generate a synthetic response (e.g., the synthetic response 610).

As mentioned, the generative training data system 106 includes a satisfaction prediction manager 1006. In particular, the satisfaction prediction manager 1006 generates, modifies, alters, or augments a predicted satisfaction label (e.g., the predicted satisfaction label 714) corresponding to a synthetic prompt and a synthetic response. For example, the satisfaction prediction manager 1006 processes inputs from the persona emulation manager 1002 (e.g., the synthetic prompt 310, the conversational goal 304, and the information data object 306) and the agent emulation manager 1004 (e.g., the digital document 602 and the synthetic response 610) through an LLM (e.g., the satisfaction prediction LLM 1018) to generate a predicted satisfaction label.

As mentioned, the generative training data system 106 includes a training dataset manager 1008. In particular, the training dataset manager 1008 generates, modifies, alters, augments, or stores a training dataset. For example, the training dataset manager 1008 generates a library of synthetic conversations emulating conversations between an LLM emulating a user (e.g., the persona emulation LLM 1014) and an LLM emulating an AI agent (e.g., the agent emulation LLM 1016) and stores the library of synthetic conversations as a training dataset for training an AI agent. In some embodiments, the training dataset manager 1008 uses the training dataset to train an AI agent model.

The generative training data system 106 further includes a storage manager 1010. The storage manager 1010 operates in conjunction with the other components of the generative training data system 106 and includes one or more memory devices such as the database 1012 (e.g., the database 116) that stores various data such as digital documents and other information. In some cases, the storage manager 1010 also manages or maintains a persona emulation LLM 1014, an agent emulation LLM 1016, a satisfaction prediction LLM 1018, and one or more additional LLM’s 1020 for generating a training dataset using one or more components of the generative training data system 106 as described above.

In one or more embodiments, each of the components of the generative training data system 106 are in communication with one another using any suitable communication technologies. Additionally, the components of the generative training data system 106 are in communication with one or more other devices including one or more client devices described above. It will be recognized that although the components of the generative training data system 106 are shown to be separate in FIG. 10, any of the subcomponents may be combined into fewer components, such as into a single component, or divided into more components as may serve a particular implementation. Furthermore, although the components of FIG. 10 are described in connection with the generative training data system 106, at least some of the components for performing operations in conjunction with the generative training data system 106 described herein may be implemented on other devices within the environment.

The components of the generative training data system 106 include software, hardware, or both. For example, the components of the generative training data system 106 include one or more instructions stored on a computer-readable storage medium and executable by processors of one or more computing devices (e.g., the computing device(s) 1000). When executed by the one or more processors, the computer-executable instructions of the generative training data system 106 cause the computing device(s) 1000 to perform the methods described herein. Alternatively, the components of the generative training data system 106 comprise hardware, such as a special purpose processing device to perform a certain function or group of functions. Additionally, or alternatively, the components of the generative training data system 106 include a combination of computer-executable instructions and hardware.

Furthermore, the components of the generative training data system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the generative training data system 106 may be implemented as part of a stand-alone application on a personal computing device or a mobile device. Alternatively, or additionally, the components of the generative training data system 106 may be implemented in any application that allows creation and delivery of content to users, including, but not limited to, ADOBE® applications such as ACROBAT®, ACROBAT STANDARD, DOCUMENT CLOUD®, and ACROBAT MOBILE. “ADOBE,” “ACROBAT” and “DOCUMENT CLOUD,” are either registered trademarks or trademarks of Adobe Inc. in the United States and/or other countries.

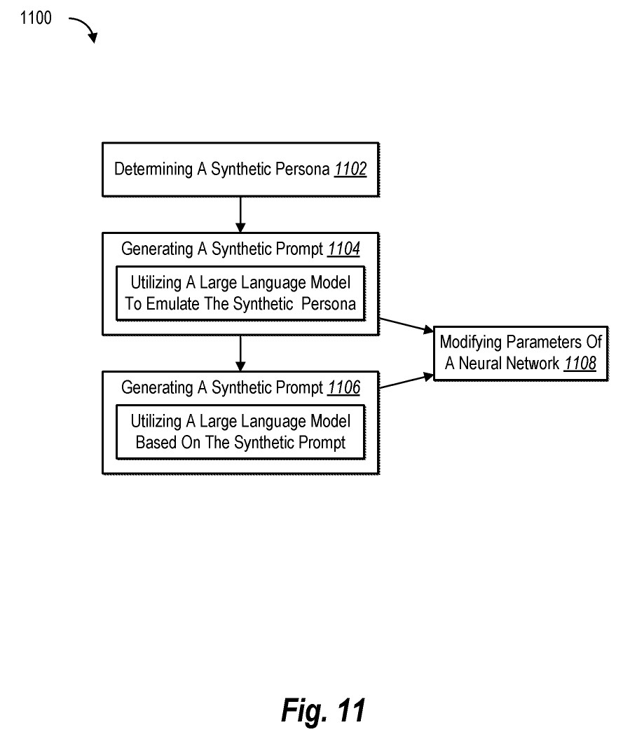

FIGS. 1-10, the corresponding text, and the examples provide a number of different systems, methods, and non-transitory computer readable media for generating a training dataset by emulating a conversation between an LLM emulating a user and an LLM emulating an AI agent about an associated digital document, so as to generate a training dataset more closely emulating user and AI agent interactions. In addition to the foregoing, embodiments can also be described in terms of flowcharts comprising acts for accomplishing a particular result. For example, FIG. 11 illustrates a flowchart of example sequences or series of acts in accordance with one or more embodiments.

While FIG. 11 illustrates acts according to particular embodiments, alternative embodiments may omit, add to, reorder, and/or modify any of the acts shown in FIG. 11. The acts of FIG. 11 can be performed as part of a method. Alternatively, a non-transitory computer readable medium can comprise instructions, that when executed by one or more processors, cause a computing device to perform the acts of FIG. 11. In still further embodiments, a system can perform the acts of FIG. 11. Additionally, the acts described herein may be repeated or performed in parallel with different instances of the same or other similar acts.

FIG. 11 illustrates an example series of acts 1100 for generating a training dataset for AI agents. In particular, the series of acts 1100 includes an act 1102 of determining a synthetic persona. For example, the act 1102 involves determining a synthetic persona by selecting a plurality of characteristics defining the synthetic persona. Further, the series of acts 1100 includes an act 1104 of generating a synthetic prompt. For example, the act 1104 involves generating a synthetic prompt emulating text input by the synthetic persona by utilizing a first language model to process a digital document associated with the synthetic persona. Further, the series of acts 1100 includes an act 1106 of generating a synthetic prompt. For example, the act 1106 involves generating a synthetic response emulating text generated by an artificial intelligence agent responsive to the text input by the synthetic persona by utilizing a second large language model to process the synthetic prompt. Further, the series of acts 1100 includes an act 1108 of modifying parameters of a neural network. For example, the act 1108 involves modifying parameters of a neural network using the synthetic prompt and the synthetic response as training data.

In some embodiments, the series of acts 1100 includes selecting the plurality of characteristics defining the synthetic persona comprises defining, for each of a set of characteristics, a binary indication of a first characteristic or a second characteristic wherein defining the binary indication of the first or the second characteristic comprises selecting a value for a professionalism characteristic, and expertise characteristic, and a reading detail characteristic.

In some embodiments, the series of acts 1100 includes generating a goal prompt instructing a large language model to generate a conversational goal for the synthetic persona, the goal prompt including the digital document, a goal category, and the synthetic persona; generating an information data object by prompting the large language model to process the conversational goal and the digital document according to a data object prompt defining a format for the information data object; and generating the synthetic prompt by prompting the first large language model to process the synthetic persona, the conversational goal, and the information data object.

In some embodiments, the series of acts 1100 includes selecting the goal category from a set of goal categories; generating the conversational goal based on the goal category, the synthetic persona, and the digital document; and generating a description prompt of the conversational goal.

In some embodiments, the series of acts 1100 includes extracting, from the digital document, a set of concepts related to the conversational goal; generating, using the large language model to process the set of concepts, a set of candidate questions corresponding to a concept among the set of concepts; and combining the set of concepts and the set of candidate questions into the information data object.

In some embodiments, the series of acts 1100 includes generating a response prompt instructing the second large language model to generate the synthetic response, the response prompt comprising a combination of the digital document and the synthetic prompt from the first large language model; and attaching the digital document, generating a summary of the digital document, or extracting a set of textual features from the digital document.

In some embodiments, the series of acts 1100 includes generating a predicted satisfaction label by prompting a large language model with the synthetic prompt, the synthetic response, a conversational goal, and the digital document; conditioning the second large language model on the predicted satisfaction label; and generating a subsequent synthetic response from the conditioned second large language model.

In some embodiments, the series of acts 1100 includes generating, utilizing a first large language model conditioned on a synthetic persona, a synthetic prompt emulating text input by the synthetic persona relating to a digital document; generating, utilizing a second large language model conditioned on the digital document, a synthetic response corresponding to the synthetic prompt and emulating text generated by an artificial intelligence agent responsive to the text input by the synthetic persona; determining, utilizing a third large language model to process the synthetic prompt and the synthetic response, a predicted satisfaction label from among a set of candidate satisfaction labels; and generating, utilizing the first large language model conditioned on the synthetic persona, a subsequent synthetic prompt based on the predicted satisfaction label.

In some embodiments, the series of acts 1100 includes generating a conversational goal by prompting a large language model to generate a conversation goal for the synthetic persona; generating an information data object by prompting the large language model to process the conversational goal and one or more extracted features from the digital document according to a data object prompt; and generating the synthetic prompt by prompting the first large language model to process the synthetic persona, the conversational goal, and the information data object.

In some embodiments, the series of acts 1100 includes prompting the large language model to generate a set of one or more conversational goals related to the synthetic persona and the digital document; and select the conversational goal from the set of one or more conversational goals.

In some embodiments, the series of acts 1100 includes prompting the third large language model with: a conversational goal associated with the synthetic persona; an information data object associated with the conversational goal and the digital document; a set of prior synthetic prompts and synthetic responses generated by the first large language model and the second large language model; and the digital document.

In some embodiments, the series of acts 1100 includes generating, utilizing the third large language model, a similarity score based on comparing the synthetic response to the synthetic prompt to one or more of: a question within the information data object; a concept extracted from the question; or the conversational goal associated with the synthetic persona.

In some embodiments, the series of acts 1100 includes generating the subsequent synthetic prompt based on the predicted satisfaction label comprises: determining, based on the predicted satisfaction label, a synthetic dialogue act defining language for the subsequent synthetic prompt; and generating the subsequent synthetic prompt from the synthetic dialogue act; and providing, to the first large language model, a prompt comprising a set of instructions based on a combination of the synthetic persona and the synthetic dialogue act.

In some embodiments, the series of acts 1100 includes generating, utilizing a persona emulation model, a synthetic prompt emulating text input by a synthetic persona; generating, utilizing an agent emulation model, a synthetic response corresponding to the synthetic prompt and emulating text generated by an artificial intelligence agent; determining, utilizing a satisfaction prediction model, a predicted satisfaction from the synthetic prompt and the synthetic response; and generating a training dataset by generating an additional synthetic prompt and an additional synthetic response according to the predicted satisfaction.

In some embodiments, the series of acts 1100 includes generating an initial prompt utilizing the persona emulation model; and modifying, utilizing a rephrasing prompt, the initial prompt to generate the synthetic prompt by rephrasing the initial prompt using different language; and modifying the initial prompt to generate the synthetic prompt comprises inserting a reference to a corresponding prior synthetic response.

In some embodiments, the series of acts 1100 includes generating the synthetic response comprises prompting the agent emulation model to evaluate a synthetic conversation history comprising prior synthetic prompts generated by the persona emulation model and further comprising synthetic responses generated by the agent emulation model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In one or more embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

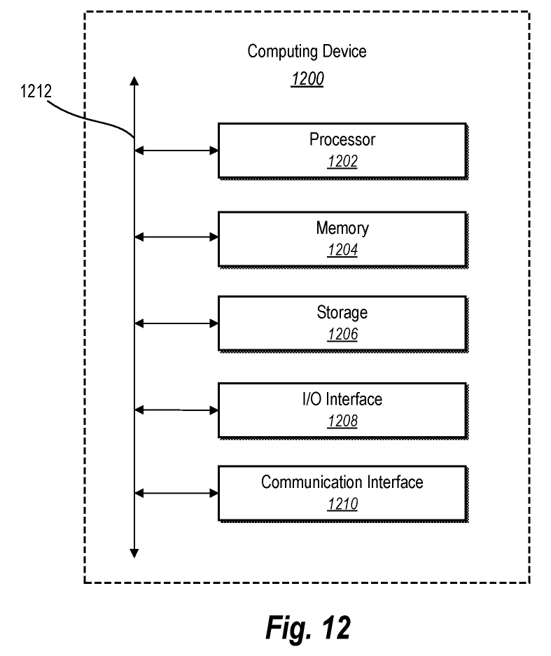

FIG. 12 illustrates a block diagram of an example computing device 1200 that may be configured to perform one or more of the processes described above. One will appreciate that one or more computing devices, such as the computing device 1200 may represent the computing devices described above (e.g., computing device(s) 1000, server device(s) 102, and client device 118). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 10, the components illustrated in FIG. 10 are not intended to be limiting. Additional or alternative components may be used in other embodiments. Furthermore, in certain embodiments, the computing device 1200 includes fewer components than those shown in FIG. 10. Components of the computing device 1200 shown in FIG. 10 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
determining a synthetic persona by selecting a plurality of characteristics defining the synthetic persona;
generating, utilizing a first large language model to process a digital document associated with the synthetic persona, a synthetic prompt emulating text input by the synthetic persona;
generating, utilizing a second large language model to process the synthetic prompt, a synthetic response emulating text generated by an artificial intelligence agent responsive to the text input by the synthetic persona; and
modifying parameters of a neural network using the synthetic prompt and the synthetic response as training data.

2. The method of claim 1, wherein selecting the plurality of characteristics defining the synthetic persona comprises defining, for each of a set of characteristics, a binary indication of a first characteristic or a second characteristic.

3. The method of claim 2, wherein defining the binary indication of the first or the second characteristic comprises selecting a value for a professionalism characteristic, and expertise characteristic, and a reading detail characteristic.

4. The method of claim 1, wherein generating the synthetic prompt further comprises:
generating a goal prompt instructing a large language model to generate a conversational goal for the synthetic persona, the goal prompt comprising the digital document, a goal category, and the synthetic persona;
generating an information data object by prompting the large language model to process the conversational goal and the digital document according to a data object prompt defining a format for the information data object; and
generating the synthetic prompt by prompting the first large language model to process the synthetic persona, the conversational goal, and the information data object.

5. The method of claim 4, wherein generating the conversational goal for the synthetic persona comprises:
selecting the goal category from a set of goal categories;
generating the conversational goal based on the goal category, the synthetic persona, and the digital document; and
generating a description prompt of the conversational goal.

6. The method of claim 4, wherein generating the information data object comprises:
extracting, from the digital document, a set of concepts related to the conversational goal;
generating, using the large language model to process the set of concepts, a set of candidate questions corresponding to a concept among the set of concepts; and
combining the set of concepts and the set of candidate questions into the information data object.

7. The method of claim 1, wherein generating the synthetic response further comprises generating a response prompt instructing the second large language model to generate the synthetic response, the response prompt comprising a combination of the digital document and the synthetic prompt from the first large language model.

8. The method of claim 7, wherein generating the response prompt comprises one or more of attaching the digital document, generating a summary of the digital document, or extracting a set of textual features from the digital document.

9. The method of claim 1, wherein modifying parameters of the neural network comprises:
generating a predicted satisfaction label by prompting a large language model with the synthetic prompt, the synthetic response, a conversational goal, and the digital document;
conditioning the second large language model on the predicted satisfaction label; and
generating a subsequent synthetic response from the conditioned second large language model.

10. A system comprising:
a memory component; and
one or more processing devices coupled to the memory component, the one or more processing devices to perform operations comprising:
generating, utilizing a first large language model conditioned on a synthetic persona, a synthetic prompt emulating text input by the synthetic persona relating to a digital document;
generating, utilizing a second large language model conditioned on the digital document, a synthetic response corresponding to the synthetic prompt and emulating text generated by an artificial intelligence agent responsive to the text input by the synthetic persona;
determining, utilizing a third large language model to process the synthetic prompt and the synthetic response, a predicted satisfaction label from among a set of candidate satisfaction labels; and
generating, utilizing the first large language model conditioned on the synthetic persona, a subsequent synthetic prompt based on the predicted satisfaction label.

11. The system of claim 10, wherein generating the synthetic prompt comprises:
generating a conversational goal by prompting a large language model to generate a conversation goal for the synthetic persona;
generating an information data object by prompting the large language model to process the conversational goal and one or more extracted features from the digital document according to a data object prompt; and
generating the synthetic prompt by prompting the first large language model to process the synthetic persona, the conversational goal, and the information data object.

12. The system of claim 11, wherein generating the conversational goal comprises:
prompting the large language model to generate a set of one or more conversational goals related to the synthetic persona and the digital document; and
select the conversational goal from the set of one or more conversational goals.

13. The system of claim 10, wherein determining the predicted satisfaction label further comprises prompting the third large language model with:
a conversational goal associated with the synthetic persona;
an information data object associated with the conversational goal and the digital document;
a set of prior synthetic prompts and synthetic responses generated by the first large language model and the second large language model; and
the digital document.

14. The system of claim 13, wherein determining the predicted satisfaction label comprises generating, utilizing the third large language model, a similarity score based on comparing the synthetic response to the synthetic prompt to one or more of:
a question within the information data object;
a concept extracted from the question; or
the conversational goal associated with the synthetic persona.

15. The system of claim 10, wherein generating the subsequent synthetic prompt based on the predicted satisfaction label comprises:
determining, based on the predicted satisfaction label, a synthetic dialogue act defining language for the subsequent synthetic prompt; and
generating the subsequent synthetic prompt from the synthetic dialogue act.

16. The system of claim 15, wherein generating the subsequent synthetic prompt further comprises providing, to the first large language model, a prompt comprising a set of instructions based on a combination of the synthetic persona and the synthetic dialogue act.

17. A non-transitory computer readable medium comprising instructions that, when executed by at least one processor, cause a computing device to perform operations comprising:
generating, utilizing a persona emulation model, a synthetic prompt emulating text input by a synthetic persona;
generating, utilizing an agent emulation model, a synthetic response corresponding to the synthetic prompt and emulating text generated by an artificial intelligence agent;
determining, utilizing a satisfaction prediction model, a predicted satisfaction from the synthetic prompt and the synthetic response; and
generating a training dataset by generating an additional synthetic prompt and an additional synthetic response according to the predicted satisfaction.

18. The non-transitory computer readable medium of claim 17, wherein generating the synthetic prompt comprises:
generating an initial prompt utilizing the persona emulation model; and
modifying, utilizing a rephrasing prompt, the initial prompt to generate the synthetic prompt by rephrasing the initial prompt using different language.

19. The non-transitory computer readable medium of claim 18, wherein modifying the initial prompt to generate the synthetic prompt comprises inserting a reference to a corresponding prior synthetic response.

20. The non-transitory computer readable medium of claim 17, wherein generating the synthetic response comprises prompting the agent emulation model to evaluate a synthetic conversation history comprising prior synthetic prompts generated by the persona emulation model and further comprising synthetic responses generated by the agent emulation model.
